(19) United States
(12) Patent Application Publication
(10) Pub. No.: US 2014/0335861 A1
(43) Pub. Date: Nov. 13, 2014

(54) Methods and Apparatus for Handover Management

(71) Applicant: NOKIA SIEMENS NETWORKS OY, Espoo (FI)

(72) Inventors: Rossella De Benedittis, Ulm (DE); Juergen Mayer, Blaustein (DE); Sean Kelley, Hoffman Estates, IL (US)

(73) Assignee: Nokia Siemens Networks Oy, Espoo (FI)

(21) Appl. No.: 13/889,530

(22) Filed: May 8, 2013

(51) Int. Cl. H04W 36/00

(52) U.S. Cl. CPC H04W 36/0083
USPC 455/436

(57) ABSTRACT

Systems and techniques for handover management. A serving base station identifies one more candidate base stations as candidates to receive a handover of a user device and selects a target base station to receive the access request from the user device. The serving base station prepares the candidate base stations to receive the user device's access request and sends a connection reestablishment command to the user device, identifying the target base station by physical cell identifier and frequency. The user device synchronizes to the target base station identified by the physical cell identifier and frequency and performs a connection reestablishment request procedure with respect to the target base station.

### TECHNICAL FIELD

The present intention relates generally to wireless communication. More particularly, the invention relates to improved systems and techniques for handover of user devices between base stations.

### BACKGROUND

As the number of wireless cellular data communication devices continues to increase and as their data capabilities continue to be more and more heavily used, the demands on available infrastructure and frequencies continue to increase. The addition of infrastructure to meet demand is costly, and is becoming more and more difficult as unoccupied space suitable for placement of larger base stations diminishes. In addition, as saturation of available wireless communication frequencies approaches, addition of conventional infrastructure approaches a point of ineffectiveness.

In order to support the growing demand for data communication services, therefore, network operators are turning more and more to managing existing resources, particularly frequency resources, so as to increase the number of users served by the resources. Traditionally, users have been served by deployments of larger base stations, with each base station defining and providing radio coverage to one or more cells which constitute a relatively wide area. In networks configured according to third generation partnership project (3GPP) long term evolution (LTE) standards and specifications, base station may be implemented eNodeBs (eNBs) which may conveniently be referred to using terms such as macro eNB, micro eNB, femto eNB, and other similar terms, in order to distinguish their relative sizes and scopes of coverage, and may define one or more macro cells, micro cells, femto cells, and the like. One approach to increasing the number of users that may be served is the deployment of smaller, lower power base stations, which may typically define one cell, although more than one cell is also possible. Dense deployment of smaller base stations can substantially increase the capacity by allowing the reuse of frequencies within a macro cell.

### SUMMARY

In one embodiment of the invention, an apparatus comprises at least one processor and memory storing computer program code. The memory storing the computer program code is configured to, with the at least one processor, cause the apparatus to at least, based on a measurement report from a user device, identify a plurality of candidate base stations as candidates to receive a handover of the user device, wherein the plurality of candidate base stations have the same physical cell identifier and carrier frequency, prepare all of the plurality of candidate base stations to receive an access request from the above said user device, and configure a connection reestablishment command message for transmission to the user device, wherein the connection reestablishment command comprises identification of the target physical cell identifier and carrier frequency and a command directing the user device to perform a connection reestablishment request procedure with respect to the identified target.

In another embodiment of the invention, an apparatus comprises at least one processor and memory storing computer program code. The memory storing the computer program code is configured to, with the at least one processor, cause the apparatus to at least, in response to a message from a serving base station comprising identification of a physical cell identifier and carrier frequency for a target base station and a command directing a user device to perform a connection reestablishment request procedure with respect to the identified target base station, cause the user device to synchronize to a target base station identified in the message by physical cell identifier and frequency and cause the user device to perform a connection reestablishment request procedure with respect to the target base station.

### BRIEF DESCRIPTION OF THE DRAWINGS

FIG. 1 illustrates a wireless communications network according to an embodiment of the present invention;

FIG. 2 illustrates a process according to an embodiment of the present invention; and

FIG. 3 illustrates elements that may be used in practicing embodiments of he present invention.

### DETAILED DESCRIPTION

Embodiments of the present invention recognize that various factors related to the efficient use of frequency resources and other considerations tend to increase the importance of efficient handover of mobile devices from one base station to another. One factor tending to emphasize the importance of efficient handover includes, increasing the number of smaller base stations, which increases the frequency of handover of mobile devices from one base station to another. As the frequency of handover increases, handover efficiency becomes increasingly important and improvements in handover efficiency yield greater benefits. One element of handover that involves considerable signaling and information exchange is the decision as to which base station is to receive the handover. Approaches to such a decision are addressed on U.S. application Ser. No. 13/862,833, filed on 15 Apr. 2013, assigned to a common assignee with the present invention and incorporated by reference herein in its entirety.

Embodiments of the present invention address limitations of conventional approaches. Examples of conventional approaches include those of systems following existing third generation partnership project (3GPP), 3GPP long term evolution (LTE) and 3GPP LTE-Advanced (3GPP LTE-A) specifications. Base stations used in such systems are generally referred to as eNodeBs or eNBs and user devices are generally referred to as UEs.

In conventional approaches, the UE measures conditions prevailing in neighbor cells. Based on the UE measurement reports, the serving eNB determines whether to initiate a handover and also identifies the target cell to which handover is to be made. In a typical conventional measurement report, the UE indicates only the physical cell identity (PCI) and (through the reported measurements) the carrier frequency of the measured cells. The serving eNB selects a target cell and prepares the target cell to receive a connection with the UE, suitably using an X2 or S1 handover preparation procedure.

The serving eNB then commands the UE to connect to the target cell, suitably through a radio resource control (RRC) connection reconfiguration procedure. Before using the assigned dedicated resources, the UE performs a random access procedure to acquire time and power synchronization with the new serving cell. Once the UE achieves access, it will also re-establish the PDCP and the RLC protocol layers.

Such a procedure may also be used when a secondary cell is to be reconfigured as the new primary cell for a UE configured in carrier aggregation. Such reconfiguration may be performed, for example, when one or more configured secondary cells exhibits better conditions than the current prima cell. A handover procedure may also be performed to conduct an intra cell handover, which may be performed when a parameter of the dedicated resources is to be changed, or to activate a new encryption key.

Embodiments of the present invention address problems posed by such conventional measures. Problems include conditions presenting ambiguity between possible target cell, conditions in which conventional approaches would call for control and information exchange that would be unnecessary under the circumstances.

For example, two different candidate target cells might share a physical cell ID (PCI)-frequency combination. One of these cells might be selected as handover target and prepared for handover, but then the UE, receiving the Handover Command from the selected target cell, might access the other of the two cells that has not been prepared for handover. The UE would then fail the handover and then initiate an RRC connection reestablishment procedure to the same cell or to a different cell. Eventually, the UE would be expected to connect to this cell, if previously prepared by serving eNB for the UE connection re-establishment, but this might take more than one attempt, and would degrade throughput and system performance.

Other problems arise when conventional approaches call for superfluous signaling. For example, a secondary cell (Scell) might need to be reconfigured as a primary cell (Pcell), such as when the Scell is performing better than the Pcell or when the Pcell is overloaded or needs to be switched off. In such situations, a conventional handover will require the UE to perform a RACH procedure with the Scell and to re-start the PDCP and RLC protocol layers, even though the UE is already time and power synchronized to the SCell and even if PDCP and RLC layers are common between the Pcell and the SCell.

Another situation in which conventional approaches cause superfluous use of resources is the initiation of a change of information or parameters at the UE, such as the activation of a new encryption key or changing of dedicated resource information such as bearer identity or a measurement resource pattern on a primary cell. In conventional approaches, the UE performs an intra-cell handover carrying out the RACH procedure and restarting the PDCP and RLC protocol layers, even when this is not needed.

In one or more embodiments, therefore, the invention provides for mechanisms for forcing the UE to make a connection re-establishment to a given physical cell identifier and a carrier frequency which may be associated to one or to a plurality of cells that have been prepared to accept the UE, rather than directing the UE to make a handover to a specific cell that may have been ambiguously identified. The serving eNB prepares all potential candidate cells to which the UE might be handed over to accept that UE and provides the UE with the appropriate physical cell identifier (PCI) and carrier frequency of the cell which it has to access. Rather than waiting for a handover failure, the serving eNB forces the UE to make an RRC connection re-establishment procedure to a cell characterized by a given physical cell identifier and carrier frequency. Based on a measurement report from a UE, the serving eNB is able to determine that a handover is needed, to identify the physical cell identifier and the carrier frequency of the candidate target eNB cells to which the UE can be handed over, to prepare those candidate target cells to receive the UE, and to indicate to the UE the selected target cell to which it should hand over. However, because the handover command comes in the form of a command to perform an RRC Connection re-establishment to a given physical cell identifier and a carrier frequency, the UE will likely succeed to access the selected target cell even if its global identity, Cell Global Identity (CGI), is ambiguous and not known by the source eNB. All possible candidate target eNB cells, that is, all cells sharing the same physical cell identifier and carrier frequency, will have been prepared to receive the UE, and the UE will successfully connect to that target eNB cell having the designated PCI-frequency pair that appears to the UE as the best handover candidate.

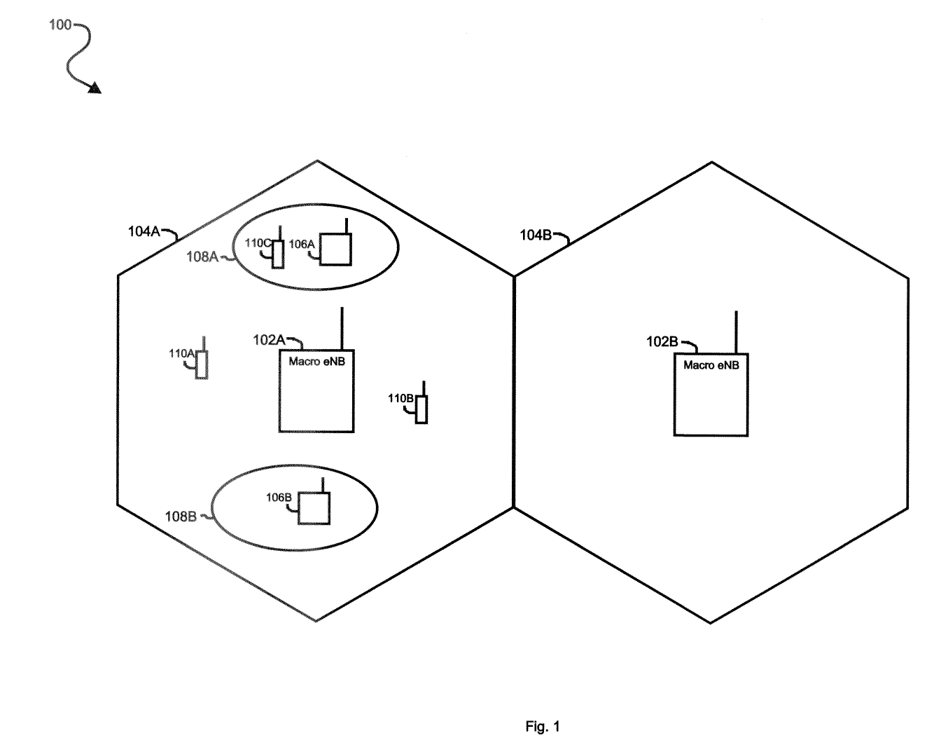

FIG. 1 illustrates a network 100 according to an embodiment of the present invention. The network 100 comprises macro eNBs 102A and 102B, whose coverage area defines cells 104A and 104B, respectively. The network also comprises femto eNBs 106A and 106B, whose coverage area defines femto cells 108A and 108B, lying within the macro cell 104A. In the present example, the network 100 is shown as serving UEs 110A, 110B, and 110C.

The various UEs provide measurement reports to their serving eNBs, and the serving eNBs determine if handover is appropriate based on the reports. In the present example, suppose that the UEs 110A and 110B are connected to the eNB 102A and the UE 110C is connected to the eNB 102B. That is, the UEs 110A and 110B are each in an RRC_CONNECTED state with respect to the eNB 102A, and the UE 110C is in an RRC_CONNECTED state with respect to the eNB 102B. The UE 110C is in a location in which a handover may be desirable, and each UE's serving eNB will determine whether conditions warrant handover of the UE and make determinations directed toward identifying the cell to which handover is to be made. In one or more embodiments of the invention, the eNBs 102A and 102B are adapted so that they prepare not a single handover target cell, but all possible handover target cells to which the UE can gain access. The handover target cell is identified to the UE by PCI and frequency pair, as part of a direction to the LE to perform an RRC Connection Re-establishment procedure, which in conventional approaches is performed only when a handover fails. For example, suppose that the measurement report provided to the serving eNB 102B by the UE 110C indicates poor signaling conditions towards the serving cell 104B, and better signaling conditions towards cell 104A of eNB 102A and cell 108A of eNB 106A. The eNB 102B then identifies the best neighbor cells, which in the present case may be the cells 104A, and 108A. Suppose that eNB 102B identifies the cell 104A as the target cell for handover. The eNB 102B then prepares both the macro cell 104A of eNB 102A and the femto cell 108A of eNB 106A to accept the UE access request and it sends to the UE a message, which may be referred to as radio resource control RRC:ConnectionReestablishmentCommand message as defined in detail below, including identifying information of the selected target cell. This identifying information may be, for example, the physical cell ID (PCI), and may include frequency information of Cell 104A of eNB 102A. The message may include an indication as to whether the UE should initiate the random access channel procedure or apply the most recent key received from the mobility management entity (MME) controlling the network 100 or re-start the PDCP and RLC protocol layer. If RACH is not requested, the evolved universal terrestrial radio access network (EUTRAN), as embodied by the eNB 102B, grants the UE 110C the uplink resources needed for sending an RRC:ConnectionReestablishmentRequest message. The following table proposes one possible coding for the RRC:ConnectionReestablishmentCommand message, which represents a new message as compared with those used in previous approaches, such as messages defined in existing 3GPP technical specifications:

| IE/Group Name | Presence | Comments |
|---|---|---|
| Message Type | M | |
| Reestablishment cell: | | |
| >PhysCellId | M | Coding as in 3GPP TS 36.331 |
| > ARFCN-ValueEUTRA | M | Coding as in 3GPP TS 36.331 |
| RACH parameters: | | |
| > RACHProcedureRequired | M | Boolean {True; False}: |
| | | indicates whether or not the |
| | | UE should do a RACH |
| | | procedure before the RRC: |
| | | ConnectionReestablish- |
| | | mentRequest |
| > RACH-ConfigDedicated | O | Coding as in 3GPP TS 36.331 |
| > keyChangeIndicator | M | Coding as in 3GPP TS 36.331 |
| > > PDCP-RLCReestab- | O | Enumerated {required} |
| lishment | | |

The UE 110C, upon receiving the RRC:ConnectionReestablishmentCommand message, enters an RRC Connection Re-establishment procedure, which is similar in many respects to procedures known in the art—for example, defined by existing third generation partnership project technical specifications defining the Connection Re-establishment procedure—but has the following differences:

The UE searches for and synchronizes to the cell defined by the received PCI and carrier frequency. That is, the UE identifies one cell associated with the received PCI and using the specified frequency. For example, as noted above, the eNB 102B may choose to indicate the PCI and carrier frequency of the macro cell 104A of eNB 102A as the candidate cell for the RRC connection re-establishment, and the UE 110C may search for cells with that very same PCI and carrier frequency, in order to achieve access to one or more of such cells. The macro eNB 102B identified the macro cell 104A of eNB 102A as the handover candidate, but suppose the cell 104A of eNB 102A and the cell 108A of eNB 106A are both using the same PCI-frequency pair. The UE 110C is here shown to be under the radio coverage of the cell 108A, so that in the present example, the cell 108A may provide better conditions than does the macro cell 104A. The UE 110C thus synchronizes to the eNB 106A cell 108A, rather than the eNB 102A cell 104A.

The UE reads relevant system information blocks before its access. However, such reading need not be performed if the information provided by the system information blocks is already known. This would be true, for example, if the cell identified for connection reestablishment is one of the UE current serving cells.

If the RRC:ConnectionReestablishmentCommand message specifies performing the RACH procedure, the UE 110C performs the RACH procedure, and if the RRC:ConnectionReestablishmentCommand message specifies endorsing a new encryption key, the UE 110C will endorse the new encryption key, and if the RRC:ConnectionReestablishmentCommand message specifies re-establishment of the PDCP and RLC protocols the UE 110C will restart both PDCP and RLC layers.

After the RACH procedure has been successfully performed as specified, or immediately if the RRC:ConnectionReestablishmentCommand message does not specify performing the RACH procedure, the UE 110C sends an RRC:ConnectionReestablishmentRequest message on the assigned uplink resources. The UE 110C then, uses uplink resources of its synchronized cell 108A to send the RRC:ConnectionReestablishmentRequest message, and thus attempts a connection to the eNB 106A. The connection will succeed because the macro eNB 102B has prepared both the femto eNB 106A and the macro eNB 102A, for the UE access to cell 108A and 104A respectively.

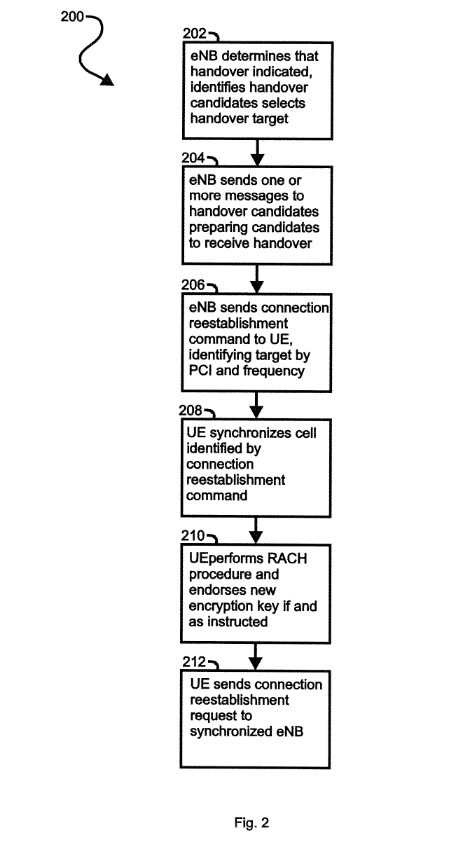

FIG. 2 illustrates a process 200 according to an embodiment of the present invention. At step 202, an eNB determines, based on measurement reports from a UE that handover of the UE is indicated, identifies handover candidates, and selects a handover target, based on the reports. At step 204, the base station sends one or more messages to prepare handover candidates to receive connection from the base station. At step 206, the eNB sends a connection reestablishment command to the UE, including identification information—specifically, PCI and frequency information. The connection reestablishment command may also provide an indication of whether the UE has to perform a random access channel (RACH) procedure.

At step 208, the UE, on receiving the connection reestablishment command, synchronizes the cell that it identifies as associated with the specified PCI and using the specified frequency. At step 210, the UE performs one or more of a RACH procedure and/or endorsement of a new encryption key and/or PDCP and RLC protocol re-establishment, if and as specified by the connection reestablishment command. At step 212, the UE performs a connection reestablishment request to the synchronized eNB, using the assigned uplink resources.

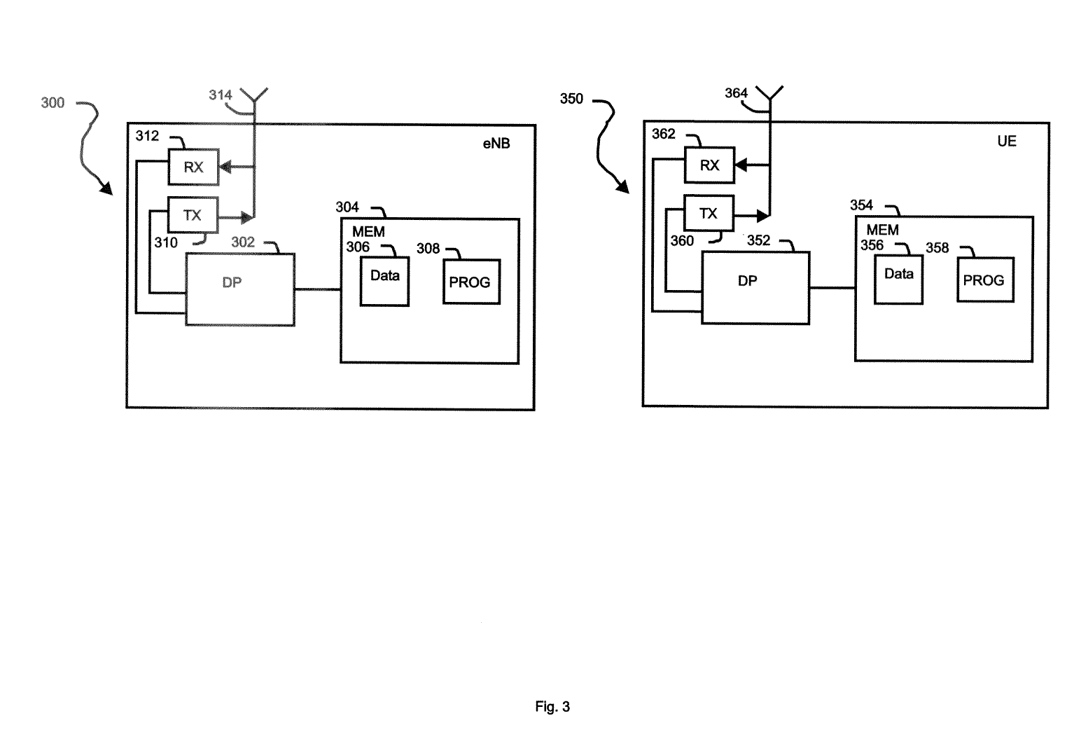

Reference is now made to FIG. 3 for illustrating a simplified block diagram of a base station, such as an eNB 300, and a user device, such as a UE 350, suitable for use in practicing the exemplary embodiments of this invention. In FIG. 3, an apparatus such as the eNB 300 is adapted for communication with other apparatuses having wireless communication capability, such as the UE 350.

The eNB 300 includes processing means such as at least one data processor (DP) 302, storing means such as at least one computer-readable memory (MEM) 304 storing data 306 and at least one computer program (PROG) 308 or other set of executable instructions, communicating means such as a transmitter TX 310 and a receiver RX 312 for bidirectional wireless communications with the UE 350 via an antenna 314.

The UE 350 includes processing means such as at least one data processor (DP) 352, storing means such as at least one computer-readable memory (MEM) 354 storing data 356 and at least one computer program (PROG) 358 or other set of executable instructions, communicating means such as a transmitter TX 360 and a receiver RX 362 for bidirectional wireless communications with the eNB 300 via one or more antennas 364.

At least one of the PROGs 308 in the eNB 300 is assumed to include a set of program instructions that, when executed by the associated DP 302, enable the device to operate in accordance with the exemplary embodiments of this invention, as detailed above. In these regards the exemplary embodiments of this invention may be implemented at least in part by computer software stored on the MEM 304, which is executable by the DP 302 of the eNB 300, or by hardware, or by a combination of tangibly stored software and hardware (and tangibly stored firmware).

Similarly, at least one of the PROGs 358 in the UE 350 is assumed to include a set of program instructions that, when executed by the associated DP 352, enable the device to operate in accordance with the exemplary embodiments of this invention, as detailed above. In these regards the exemplary embodiments of this invention may be implemented at least in part by computer software stored on the MEM 354, which is executable by the DP 352 of the UE 350, or by hardware, or by a combination of tangibly stored software and hardware (and tangibly stored firmware). Electronic devices implementing these aspects of the invention need not be the entire devices as depicted at FIG. 3 or may be one or more components of same such as the above described tangibly stored software, hardware, firmware and DP, or a system on a chip SOC or an application specific integrated circuit ASIC.

In general, the various embodiments of the UE 350 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEM 304 and 354 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DP 302 and 352 include but are not limited to general purpose computers, special purpose computers, microprocessors, digital signal processors (DSPs) and multi-core processors.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

1. An apparatus comprising:
at least one processor;
memory storing computer program code;
wherein the memory storing the computer program code is configured to, with the at least one processor, cause the apparatus to at least:
based on a measurement report from a user device, identify a plurality of candidate base stations as candidates to receive a handover of the user device, wherein the plurality of candidate base stations have the same physical cell identifier and carrier frequency;
prepare all of the plurality of candidate base stations to receive an access request from the above said user device; and
configure a connection reestablishment command message for transmission to the user device, wherein the connection reestablishment command comprises identification of the target physical cell identifier and carrier frequency and a command directing the user device to perform a connection reestablishment request procedure with respect to the identified target.

2. The apparatus of claim 1, wherein the connection reestablishment command message comprises information instructing the user device whether or not to perform a random access channel procedure.

3. The apparatus of claim 1, wherein the connection reestablishment command message comprises information instructing the user device whether or not to endorse a new encryption key.

4. The apparatus of claim 1, wherein the connection reestablishment command message comprises information instructing the user device whether or not to re-establish the packet data convergence protocol and radio link control protocol layers.

5. The apparatus of claim 1, wherein the connection reestablishment command message is a radio resource control message.

6. The apparatus of claim 1, wherein preparing the candidate base stations to receive the access request from the user device is accomplished using an X2 or S1 message.

7. An apparatus comprising:
at least one processor;
memory storing computer program code;
wherein the memory storing the computer program code is configured to, with the at least one processor, cause the apparatus to at least:
in response to a message from a serving base station comprising identification of a physical cell identifier and carrier frequency for a target base station and a command directing a user device to perform a connection reestablishment request procedure with respect to the identified target base station, cause the user device to synchronize to a target base station identified in the message by physical cell identifier and frequency; and
cause the user device to perform a connection reestablishment request procedure with respect to the target base station.

8. The apparatus of claim 7, wherein the connection reestablishment request procedure comprises sending a connection reestablishment request message to the target base station using uplink resources granted by the target base station.

9. The apparatus of claim 7, wherein the connection reestablishment request procedure comprises sending a connection reestablishment request message to the target base station using uplink resources granted by the serving base station.

10. The apparatus of claim 8, wherein the connection reestablishment request message is a radio resource control message.

11. A method comprising:
based on a measurement report from a user device, identifying a plurality of candidate base stations as candidates to receive a handover of the user device, wherein the plurality of candidate base stations have the same physical cell identifier and carrier frequency;
preparing all of the plurality of candidate base stations to receive an access request from the user device; and
configuring a connection reestablishment command message for transmission to the user device, wherein the connection reestablishment command comprises identification of the target physical cell identifier and carrier frequency and directs the user device to perform a connection reestablishment request procedure with respect to the identified target.

12. The method of claim 11, wherein the connection reestablishment command message comprises information instructing the user device whether or not to perform a random access channel procedure.

13. The method of claim 11, wherein the connection reestablishment command message comprises information instructing the user device whether or not to endorse a new encryption key.

14. The method of claim 11 wherein the connection reestablishment command message comprises information instructing the user device whether or not to re-establish the packet data convergence protocol and radio link control protocol layers.

15. The method of claim 11, wherein the connection reestablishment command message is a radio resource control message.

16. The method of claim 11, wherein preparing the candidate base stations to receive the access request from the user device is accomplished using an X2 or S1 message.

17-30. (canceled)
